(19) United States
(12) Patent Application Publication
(10) Pub. No.: US 2011/0281108 A1
(43) Pub. Date: Nov. 17, 2011

(54) SURFACE COOLING

(75) Inventors: David Peter Weston, Nottingham (GB); Philip Howard Shipway, Nottingham (GB); Samuel James Harris, Nottingham (GB); John Yellop, Nottingham (GB)

(73) Assignee: The Univeristy of Nottingham, Nottingham (GB)

(21) Appl. No.: 12/989,636

(22) PCT Filed: Apr. 23, 2009
(86) PCT No.: PCT/GB2009/001015

§ 371 Date: Mar. 22, 2011

(30) Foreign Application Priority Data
Apr. 25, 2008 (GB) 0807528.5

(51) Int. Cl. B32B 3/00; C09D 1/00; B32B 15/04; C25D 5/00; C25D 3/56; C25D 21/10

(52) U.S. Cl. 428/336; 428/457; 205/96; 106/286.3; 106/286.1

(57) ABSTRACT

Exemplary embodiments of a method, system, and apparatus for electro-plating an alloy upon a cathode. For example, a bath which includes disodium tungstate and an iron group substrate in an aqueous solution with a complexant to form complexes which remain in suspension in the bath can be provided. Further, the bath can be maintained at a temperature in the range of approximately 50-90° C. and at a pH in the range of approximately 5 to 7 and a current density in the range of approximately 1 to 4 Adm⁻².

### CROSS-REFERENCE TO RELATED APPLICATIONS

This application is the U.S. National Stage Application of International Application No. PCT/GB2009/001015, filed on Apr. 23, 2009, which was published as WO 2009/130450 on Oct. 29, 2009, and claims priority to UK Patent Application No. 0807528.5, filed on Apr. 25, 2008. The disclosures of the above-referenced applications are incorporated by reference herein in their entireties.

### FIELD OF THE DISCLOSURE

The present disclosure relates to surface coatings and in particular, to exemplary embodiments of cobalt-tungsten (Co—W) coatings utilized for wear and corrosion resistance.

### BACKGROUND INFORMATION

It is preferable to produce relatively hard coatings for wear resistance in a number of industries including those relating to automotive, aerospace, manufacturing industries and allied trades. Examples of where hard coatings can be utilized are in relation to internal combustion engine components, hydraulic cylinder components and machine tools. One exemplary hard coating includes electroplated hard chromium, which besides having resistance to indentation can have excellent wear resistance and a low coefficient of friction in the lubricated condition. Unfortunately the electrodeposition processes utilized for hard chromium electroplating typically use hexavalent chromium, which can be environmentally hazardous. In such circumstances various regulatory authorities have insisted on reductions in the use of hexavalent chromium leading to many industries abandoning or attempting to avoid the use of chromium coatings produced from this source. Thus it is desirable to find a coating which at least approaches the properties of hard chromium and potentially exceeds the performance of hard chromium coatings.

One disadvantage of electroplated chromium coatings can be that there is no protection of carbon and low alloy steels against corrosion as a result of micro cracking. In such circumstances it is generally preferable to apply an undercoat of nickel or copper to prevent corrosion of the underlying steel. It will be understood that alternative coatings such as those based upon cobalt and nickel can provide good protection for steel provided there are no defects in them. An example of a cobalt coating is provided by the cobalt-tungsten (Co—W) system. Such Co—W coatings exhibit attractive properties in relation to corrosive resistance as well as tribological performance criteria. However, properties such as good wear resistance and low coefficient of friction has hitherto been difficult to achieve, for a comparable performance to hard chromium coatings for dry and lubricated engineering applications.

As noted herein, hard chromium electrodeposits have been used in industry for many years in terms of creating coatings with good aesthetic qualities as well as functional coatings possessing high hardness, low coefficients of friction when lubricated and excellent wear properties. When such properties are combined with resistance to corrosion it is understandable that electrodeposited hard chromium can be considered highly useful in engineering applications. Unfortunately as also noted above, use of hexavalent chromium in the production of such hard chromium electrodeposits can have serious environmental consequences and therefore there is an incentive to provide alternative wear resistant coatings to replace hard chromium in engineering applications.

One possibility with regard to developing a wear and corrosion resistant electrodeposited coating can be through co-deposition of tungsten with one or more iron group metals such as iron, cobalt or nickel. Tungsten typically can not deposit by itself from aqueous solution but can co-deposit as an alloy with an iron group metal. Aqueous solutions of tungstate plus an iron group metal can generally be unstable and can precipitate out unless a suitable complexant such as a salt of carboxylic acid is utilized to complex the metal ions in solution.

Previously, it was possible to provide tungsten plus an iron group metal alloys which displayed a relatively high Vickers hardness of in the order of approximately 450 to 650 kgf mm⁻² and by heat treatment such hardnesses can be increased to that approaching hard chromium. Nevertheless, such heat treatments add significantly to manufacturing costs, procedure and may be unacceptable when the heat treating process may alter the performance of the underlying component coated. Generally current tungsten containing alloys can be deposited in an amorphous form. Very fine or nano-crystalline deposits can have significantly improved hardness values and therefore be more acceptable as substitutes for hard chromium electrodepositions for engineering functions.

As noted above, electrodepositions to form alloys by presenting a source of iron group ions such as nickel sulphate, a source of tungstate ions such as disodium tungstate and a complexing agent such as citrate in a bath controlled in terms of pH in the range 5 to 9 can be provided. Also, coating compositions which have a cobalt content of up to 75 at % can be provided. However, as indicated these deposits tend to be amorphous and therefore unless heat treated cannot provide the necessary hardness for substitution in applications currently using hard chromium coatings. Additional manufacturing processes over and above the electrodeposition process as noted above add to cost and may be unacceptable where heat treatment or otherwise would degrade the base recipient component for the electrodeposited coating.

### SUMMARY OF EXEMPLARY EMBODIMENTS

In accordance with exemplary embodiments of the present disclosure, a method of electro-plating for an iron group—tungsten (iron group-W) alloy upon a cathode can be provided. The exemplary method can include providing a bath with disodium tungstate and iron group sulphate in an aqueous solution with a complexant such as sodium gluconate to form complexes which remain in suspension in the bath which is maintained at a temperature in the range of approximately 50-90° C. and at a pH in the range of approximately 5 to 7 and operated at a current density in the range of approximately 1 to 4 amps per square decimetre.

In an exemplary embodiment, the complexant can include a sodium gluconate salt, but other carboxylic acid salts can also be employed.

In another exemplary embodiment, the iron group ions can be provided within the aqueous solution at a composition proportion up to approximately 0.5M and preferably, up to approximately 0.05M. Generally, the tungstate ions can be provided in a composition up to approximately 0.5M and preferably, up to approximately 0.05M within the aqueous solution. Generally, the gluconate ions can be provided in a composition up to approximately 1M within the aqueous solution and preferably, approximately 0.55M.

In another exemplary embodiment, the aqueous solution also can include boric acid (H₃BO₃) in a composition up to approximately 1M and preferably, approximately 0.65M.

In another exemplary embodiment, the aqueous solution can include sodium chloride at a composition up to approximately 2M and preferably, approximately 0.5M.

In an exemplary embodiment, the iron group ions can include cobalt ions provided by CoSO₄. Typically, the tungstate ions can be provided by Na₂WO₄.

In an exemplary embodiment, the gluconate ions can be provided by Na gluconate.

In an exemplary embodiment, the bath can be maintained at approximately 80° C. temperature. Typically, the current density is in the order of approximately 2.7 Adm⁻². Preferably, the bath is maintained at a pH of approximately 6.

In an exemplary embodiment, the bath can include agitation. Preferably, the agitation can be provided by gas bubbling eductor circulation or mechanical agitation.

In an exemplary embodiment, the method can be arranged to provide through the composition within the bath and/or temperature and/or current density to define a deposition rate of in the order of approximately 20 μm per hour. Possibly, the composition and/or temperature and/or current density is defined to limited deposition stressing within the deposition upon the cathode. Alternatively, the composition and/or temperature and/or current density is defined to provide a degree of compression stressing of the deposition upon the cathode.

Also in accordance with exemplary embodiments of the present disclosure there can be provided a coating formed by the exemplary methods as described above.

In accordance with exemplary embodiments of the present disclosure there can be provided a component having a coating as defined above and/or treated by a method as described above. Preferably, the coating is in the order of approximately 1 to 200 μm thick.

In an exemplary embodiment, the coating is radially columnar with a grain size cross section less than approximately 10 nm. Typically, the coating has Vickers (Hv) or Knoop (Hk) hardness greater than approximately 800 kg mm⁻².

Additionally in accordance with exemplary embodiments of the present disclosure there can be provided a coating including less than approximately 25 at % W presented as an alloy with an iron group metal with columnar crystalline grain presentation to a deposited surface in use.

### BRIEF DESCRIPTION OF THE DRAWINGS

Aspects of the present disclosure will now be described by way of example and with reference to the accompanying drawings in which:

FIG. 1 is a schematic illustration of an electroplating bath utilized in accordance with an exemplary embodiment of the present disclosure;

FIG. 2 is a graphic illustration of electrode potential versus electrical current obtained by cyclic voltammetry for a number of aqueous electroplating baths in accordance with an exemplary embodiment of the present disclosure;

FIG. 3 is a table illustrating deposited cobalt and tungsten compositions for alloys produced under potentiostatic control from bath 1 depicted in FIG. 2 at a number of electrode potential levels and with the bath either agitated or in a quiescent condition in accordance with an exemplary embodiment of the present disclosure;

FIG. 4 is a graphic depiction of Vickers hardness of cobalt-tungsten coatings produced on a low alloy steel cathode over a range of electrode potentials;

FIG. 5 is a table depicting cobalt and tungsten composition of alloy deposits produced from different concentrations of gluconate complexing agent (bath 1 and 2 as outlined in FIG. 2) at different current densities in accordance with an exemplary embodiment of the present disclosure; and,

FIG. 6 illustrates the fine nanostructure of a Co—W electroplated deposit produced from an agitated Co—W bath at a current density of 2.75 Adm⁻², in accordance with an exemplary embodiment of the present disclosure.

### DETAILED DESCRIPTION OF EXEMPLARY EMBODIMENTS

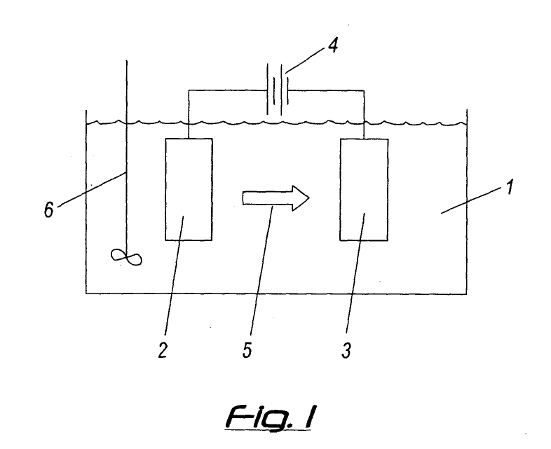

FIG. 1 illustrates schematically an electrode deposition or electroplating arrangement according to an exemplary embodiment of the present disclosure. Bath 1 can be provided having an aqueous solution incorporating metallic ions for deposition and complexing agents to prevent precipitation of the ions out of solution. A cathode 3 and an anode 2 with an external electrical voltage 4 between them can be arranged such that ions are co-deposited as an alloy upon the cathode 3 schematically depicted in the direction of arrowhead 5 with a notional consumption of the anode 2. FIG. 1 schematically illustrates agitation of the bath 1 through a stirrer 6, however, gas bubble agitation can be provided to vigorously agitate to the bath 1. The bath 1 can be maintained at a particular operating temperature to facilitate electrodeposition and/or electroplating in terms of ion mobility, and the applied electrical voltage can generate a particular electrical current between the anode 2 and the cathode 3 through the charged ions in solution within the bath 1.

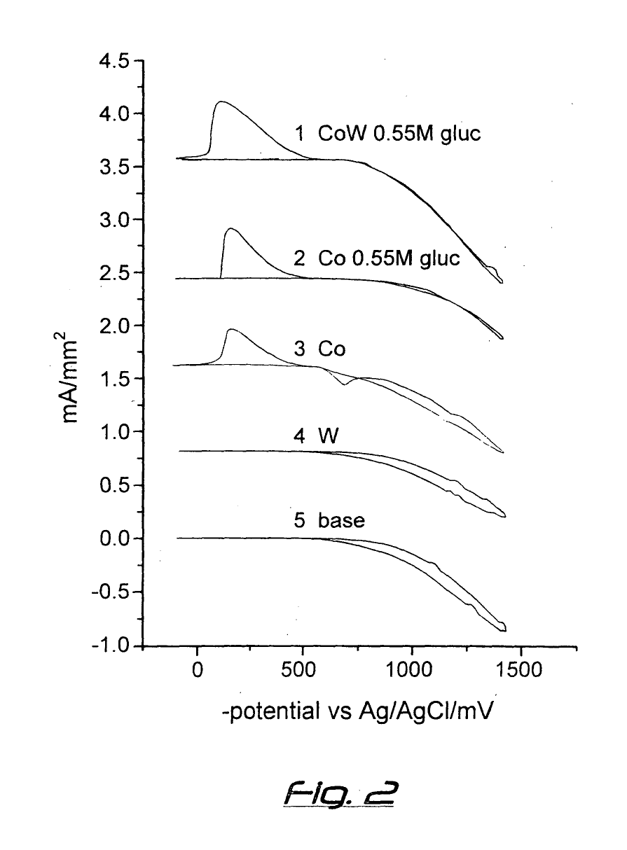

FIG. 2 provides an exemplary graphical depiction of electrical current versus potential for a number of exemplary baths compositions 1 to 5 as defined by table 1 below.

| | 1 | 2 | 3 | 4 | 5 |
|---|---|---|---|---|---|
| CoSO₄/M | 0.053 | 0.053 | 0.053 | — | — |
| Na₂WO₄/M | 0.050 | — | — | 0.050 | — |
| H₃BO₃/M | 0.65 | 0.65 | 0.65 | 0.65 | 0.65 |
| NaCl/M | 0.51 | 0.51 | 0.51 | 0.51 | 0.51 |
| Na | 0.55 | 0.55 | — | 0.55 | 0.55 |
| Gluconate/M | | | | | |

CoSO₄ 0.01 → 0.5M
Na₂WO₄ 0.01 → 0.5M
H₃BO₃ 0.01 → 1.0M
NaCl 0.01 → 2.0M
Na Gluconate 0.1 → 1.0M

The exemplary baths 1 to 5 can be prepared using chemicals in a one litre volumetric flask by combining deionised water with the chemicals in molar proportions to define the compositions. pH within the baths can be regulated to the desired pH level utilizing sodium hydroxide pellets. The pH level can be maintained in the examples given at about pH 6. The bath temperature can also be maintained at a temperature in the order of approximately 80±2° C. For the test results provided, a round bottomed flask holding 100 cl of the bath solution can be utilized and the working electrode can include a platinum wire electrode with approximately a 0.5 mm diameter and a counter electrode again formed of platinum with approximately a 2 cm² flag area. A reference electrode can be presented in the form of a silver/silver chloride in a potassium chloride solution. The cyclic voltammetry plots given in FIG. 2 were adduced utilizing an appropriate modular potentiostat with a sweep rate of approximately 20 mV per second. As indicated above, the reaction bath can be maintained through an appropriate thermostat in the temperature range 80±2° C.

As can be seen each bath can produce a different plot.

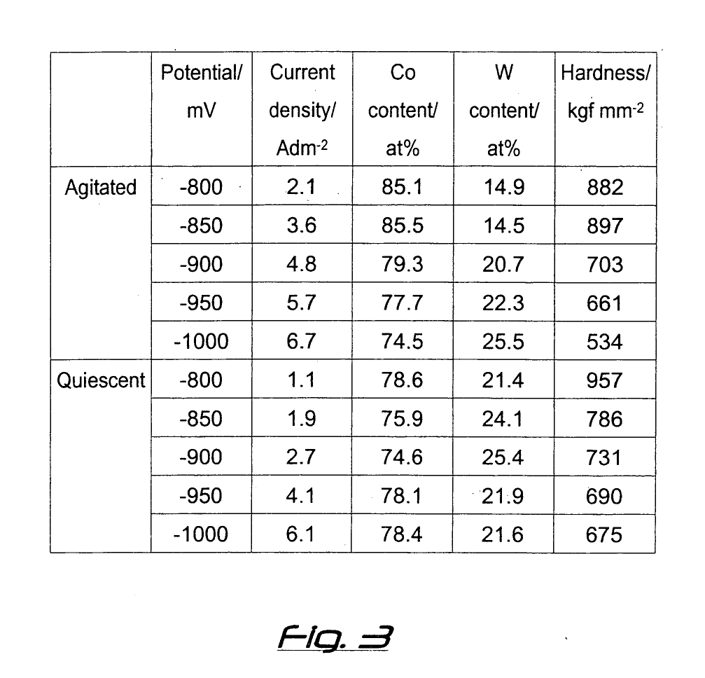

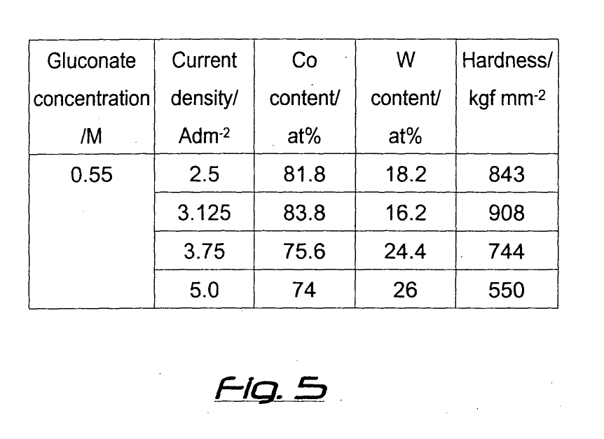

Bath 1 is an exemplary embodiment of the present disclosure in creating a cobalt-tungsten (Co—W) coating to emulate hard chromium coatings as utilized for engineering applications. FIG. 3 provides an exemplary potentiostatic plating experiment results for bath 1, while FIG. 5 provides exemplary galvanostatic plating experiments results also for bath 1. For information with regard to potentiostatic deposition, the counter electrode can be a platinum flag and the working electrode a section of mild steel of approximately 1 cm² surface area. Deposition of the alloy can be performed under various quiescent conditions and vigorous agitation conditions utilizing bubbled air. Each deposition process can be allowed to proceed for two hours. With regard to electrodeposition, this can be performed as illustrated with regard to bath 1 as outlined in the above table upon a mild steel sheet as an example of typical component material with an area approximately 4 cm². The plate can be subject to a cleaning process before pickling in approximately 10% sulphuric acid to destroy any residual base residues. The alloys can be then galvanostatically plated at the current densities illustrated for approximately 2 hours. The cathode current densities chosen can relate to those observed in the potentiostatically controlled deposition experiments described with regard to FIG. 3. An iridium oxide coated platinised titanium mesh or cobalt metal can be utilized as an anode. The temperature of the baths can be maintained at a temperature in the order of approximately 80±2° C. by immersion in a hot water bath. Throughout deposition, the solutions presented in the baths can be constantly agitated using an air bubble purge.

Coatings can be examined using a scanning electron microscope fitted with a field emission gun and an energy dispursive X-ray analyser. Furthermore, selected coatings can be examined using a cross section with a transmission electron microscope. Samples utilized for the transmission electron microscope can be mounted in cross section and thinned using an ion beam miller. Hardness measurements can be made on coating cross sections using an appropriate Knoop micro hardness indenter with a load of approximately 25 μms force for approximately 15 seconds.

Returning to FIG. 2, providing exemplary cyclic voltammograms recorded for a platinum wire electrode in baths 1 to 5 defined in table 1 above at 80° C. and pH 6. Voltammogram 5 shows that a hydrogen evolution reaction can begin at around −700 mV with respect to a silver/silver chloride reference electrode in a base solution of boric acid, sodium chloride and sodium gluconate. Voltammogram 4 can be obtained from a similar solution in similar conditions but with the addition of a tungstate ion (WO⁴)²⁻. Voltammogram for bath 4 is similar to that for bath 5 with no anodic stripping peak observed. Such results imply that the only cathodic event is due to hydrogen evolution. Voltammograms 2 and 3 can be obtained using solutions including cobalt ions (Co) without a tungstate ion but with different levels of sodium gluconate, namely approximately 0.55 M and 0 M.

The results for bath 3 without gluconate can show a cathodic current is rising at approximately −600 mV and peaking at approximately −700 mV, corresponding to Co⁺² reduction. In bath 2, with approximately 0.55 Molar gluconate, there can be a smooth cathodic curve which begins at around −750 mV. The presence of gluconate in such circumstances can decrease the total charge passed in the cathodic deposition process, but the size of the anodic stripping peak can be larger than in the absence of the gluconate species (bath 3), which would suggest that more cobalt is deposited when the gluconate is added, thus multiplying an increase in cathode efficiency.

An understanding of the effect of adding tungstate ions to bath 2 can be achieved through the investigation of the voltammogram for bath 1. The voltammogram obtained with regard to bath 1 shows an increase in cathodic activity compared to bath 2 (its notional equivalent) and a shift in initial reduction potential to a less negative value from approximately −820 to approximately −750 mV. In the case of bath 3, that is to say without gluconate, addition of the tungstate ions can result in the formation of copious, pale lilac coloured precipitate leaving a faintly pink coloured solution.

FIG. 3 provides an exemplary table of potentiostatic plating experiments with regard to bath 1 composition. However, it can be shown whether the bath is quiescent or agitated, there can be a consistent rising current density with increasing negative cathode potential. A quiescent bath can have a current density approximately half of that of an agitated bath, in a potential range of approximately −800 to −900 mV. At more negative potentials, the electrical current in the quiescent bath tends towards those observed in the agitated bath. Additionally, the tungsten content of an alloy coating deposition can increase as the negative electrical potential increases to a certain point (approximately −900 mV) in quiescent conditions, but there can be a small decrease in tungsten content at more negative potentials, and this can coincide with an accelerated increase in cathode current density. X-ray diffraction patterns obtained from potentiostatically deposited coatings can show that there is a change in structure with regard to the deposition from an aqueous bath as the potential changes from approximately −800 to −850 mV, e.g., from crystalline to amorphous. Deposits produced at more negative electrical potentials can be amorphous.

The tungsten content of deposited coatings produced potentiostatically with the air agitated baths can result in lower tungsten contents in comparison with quiescent conditions at lower negative electrode potentials than those coatings deposited at more negative potentials for agitated conditions. For example, from −850 to −1,000 mV the tungsten content of the coating can remain in the range of approximately 21 at % to 25 at %. Again, X-ray diffraction patterns can show that the increase in tungsten content of the coatings can also be accompanied by a shift from nano-crystalline to amorphous deposition.

Nano-crystalline coatings generally provide a harder and more durable nature, particularly with regard to wear resistance.

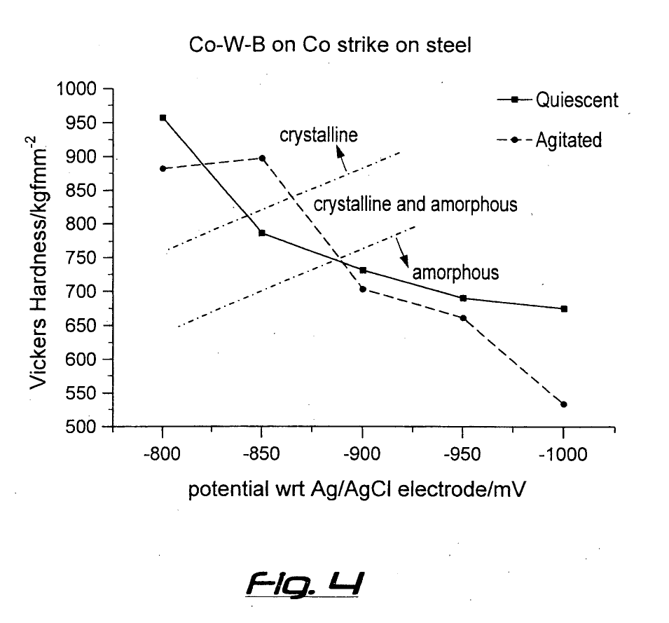

FIG. 4 provides an exemplary graphic illustration of the comparison of hardness with cathode potential. For both quiescent and agitated baths, higher hardness values can be associated with low deposition potentials and crystalline coatings. In both cases, increasing negative electrical potential can be associated with a steady decrease in hardness, although this can be more prominent with regard to agitated baths. Hard crystalline coatings with lower tungsten contents can be produced over a wider potential range in agitated baths than in quiescent baths.

Through scanning electron microscope images of the surface of a cobalt-tungsten coating produced potentiostatically under agitated conditions, it can be shown that for a potential of approximately −800 mV, a coating can be more faceted with a crystal size of in the order of approximately 5 μm, while at approximately −850 mV, the crystals can decrease in size to in the order of approximately 1 μm, and with even greater negative potentials, the deposition can approach an amorphous topography with no crystal facets.

Under galvanostatic control, deposition on larger samples (cathode area 25-200 cm²) can produce higher hardness coatings over a controlled range of electrical current densities. Electrical current density can be related to the pattern of potentiostatic deposition as well as a degree of agitation imposed upon a bath. FIG. 5 provides an exemplary table with respect to bath 1. With regard to bath 1, at a low electrical current density in the order of approximately 2.5 or 3.125 amps dm⁻², coatings can be generally crystalline, as can be deduced from the hardness for each coating. Further, at higher electrical current densities, in the order of approximately 3.75 and 5 amps dm⁻², coatings can be generally more amorphous and so produce reduced hardness values. The change from crystalline to amorphous coatings can be seen in scanning electron microscope images taken of coatings. There can be a shift in amorphous structure accompanied by an increase in tungsten content within the coating to in excess of approximately 20%. Variation in the tungsten content with current density can be similar to that produced potentiostatically with air agitation. Hardness of coatings can be higher with lower current densities, and can decrease with increasing electrical current density. These results are consistent with agitated potentiostatic determinations.

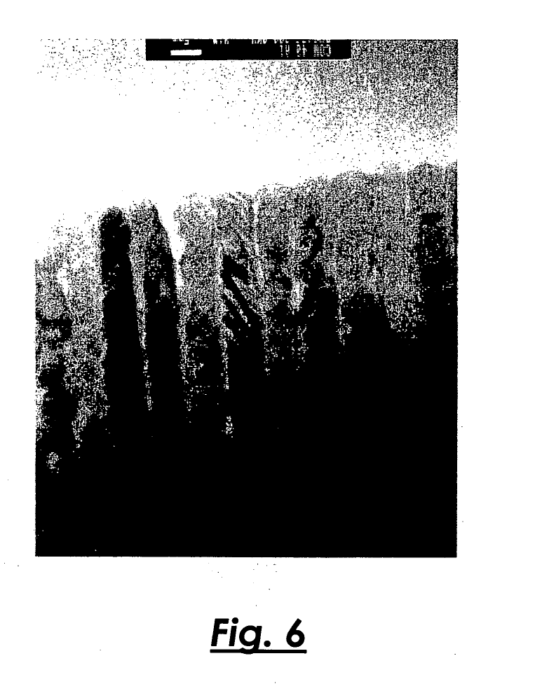

FIG. 6 shows an exemplary transmission electron microscope micrograph of an electroplated coating produced from bath 1 as described above at approximately 2.7 amps dm⁻² The coating appears to include rods (approximately 5 nm thick) in transmission, however, a scanning electron microscope analysis can indicate that these can be in the form of sheets, which can be approximately 5 nm in width and more than approximately 100 nm in height. Such fine crystalline form or nano-structure within the coating can result in a high hardness value.

Exemplary embodiments of the present disclosure relate to utilizing of a complexing agent such as gluconate. The influence of such gluconate species on the deposition of cobalt can be referenced by consideration of hydrogen evolution from the cobalt free bath 5 as indicated above; deposition of cobalt is typically accompanied by hydrogen evolution as in bath 3. It can be assumed that the onset of cobalt deposition occurs at a less negative potential when a complexing agent such as gluconate is included in the bath.

With regard to bath 2, the effects of a large addition of gluconate to in the order of approximately 0.55 M on cobalt ions can also be seen. There can be a shift in the onset of deposition to a more negative potential typically in the order of approximately −780 mV. This can be due to the presence of highly complexed cobalt ions as a result of the high ratio of gluconate present.

With regard to introduction of a tungstate into a cobalt-gluconate bath, the chemical behaviour of tungstate ions in a solution (pH 6) can be complex in the pH range of approximately 5 to 7.8. There can be an equilibria developed between the tungstate ions WO₄⁻², W₆O₂₀(OH)₂⁻⁶, W₇O₂₄⁻⁶, HW₇O₂₄⁻⁵ and H₂W₁₂O₄₂¹⁰⁻ and the cobalt-polytungstates that can be produced. UV spectroscopy can show that the presence of gluconate can result in a shift in the ion species equilibria when gluconate is added a concentration of approximately 0.55 M in bath 4. Accordingly, the potential for tungstate bonding can be much simpler in the presence of a gluconate as enabling a reduction in the tendency to form para- and meta-tungstates.

The addition of tungstate ions can result in the formation of quantities of cobalt-gluconate-tungstate ions thereby reducing the quantity of free cobalt ions and other cobalt complexes. A shift in proportion of the cobalt ions can shift the onset of deposition to a more negative potential. In a bath containing approximately 0.55 M gluconate (bath 1), the onset of deposition can occur at approximately −720 mV, which is less negative than approximately −780 mV observed with a tungstate free bath (bath 2). This may be that the result of adding tungstate ions allows gluconate-tungstate complexes to form on a scale so that these complexes remove the gluconate from the solution so that there is a freeing of more cobalt for deposition. However, if the formation of such a hypothetical gluconate rich complex were possible, it would likely remove approximately 0.1 M of gluconate from the cobalt-gluconate equilibria. By calculating the stability constant for the cobalt ion and gluconate within the bath, there is likely little effect on the cobalt ion species within the bath, thus rendering such a gluconate-tungstate complex unlikely. Alternatively, the presence of approximately 0.55 M gluconate can result in the formation of a cobalt-gluconate-tungstate species. The ability to directly reduce this species can shift the onset of deposition to a less negative potential compared to the tungsten free cobalt bath 2.

The effect of the addition of tungstate to the approximately 0.55 M gluconate bath 2 to form bath 1 can be detected by shifts in the ultraviolet absorption peaks. It may be assumed that the presence of tungstate effectively removes gluconate from the solution and creates some less complexed cobalt ions and therefore alters the state of the cobalt species within the bath. However, the case has already been made that excess of gluconate in the bath can mean that the cobalt species is unlikely to be altered by the addition of 0.05 M tungstate. A more likely explanation for the shift can be that the formation of a new cobalt complex occurs, which involves tungstate as a ligand on the cobalt, possibly replacing some of the gluconate.

Potentiostatically controlled plating experiments under agitated bath conditions can show an almost linear increase in current with increasing negative cathode potential. Under quiescent conditions, there can be an increase in the rate of current density increase as the cathode potential changes from approximately −900 mV to −1,000 mV.

Under agitated conditions, bath 1 can produce high hardness coatings at less negative potentials, and the deposits contain 14-15 at % tungsten. At greater than approximately −900 mV, there can be a sudden increase in tungsten content to an excess of approximately 20% and a marked decrease in hardness. The decrease in hardness can be in the order to approximately 200 Hk, which may be due to transition from crystalline to amorphous deposits. Crystalline, low tungsten coatings can give an X-ray diffraction pattern which may be interpreted as a solution of tungsten in hexagonal closed packed crystalline cobalt. Such a shift to amorphous structures can occur as the tungsten contents of the coating certainly exceeds approximately 20 at %. A change in the tungsten content in the coating can be indicative of the availability of both cobalt-gluconate and cobalt-gluconate-tungstate species in solution, which may decompose at different rates dependent upon their deposition potential.

Under quiescent conditions, crystalline coatings are produced at approximately −800 mV. The orientation of such crystalline deposition can be about the {100} plane and contains a surprisingly high proportion of tungsten (approximately 21 wt %). Such a sample can have a hardness of approximately 957 Hk, produced under potentiostatic conditions. At approximately −850 mV, and more negative potentials there can be an increase in tungsten content and a greater adoption of the amorphous state and a corresponding decrease in hardness, typically by in the order of approximately 170 Hk. Under quiescent conditions, the supply of cobalt and cobalt-tungsten to the cathode can be controlled by diffusion of the cobalt-gluconate and cobalt-gluconate-tungstate species. At more negative cathode potentials and higher current densities, the tungsten content within the amorphous coatings can decrease and this may again be due to diffusion control of the complexed species.

Under agitation, less tungsten may be deposited at lower cathode potentials, and this may be due to the plentiful supply of cobalt-gluconate and cobalt-gluconate-tungstate ions to the cathode along with a kinetic favourability for the deposition of cobalt-gluconate over cobalt-gluconate-tungstate species. At even more negative electrical potentials, the rate of cobalt-gluconate-tungstate decomposition can increase more rapidly and more tungsten can therefore be deposited with a plentiful supply of these complexes in the near—cathode regions due to agitation.

With galvanostatic deposition of coatings from bath 1 under agitation, there can be an increase in current density, which can give an increase in tungsten content along with a shift to the amorphous state and a corresponding decrease in hardness. The pattern of behavior can be similar to that produced by potentiostatic deposition with agitation. Scanning electron microscope pictures of the surface of galvanostatically produced coatings can be similar to those produced by potentiostatic procedures.

Electrodeposition can be carried out under galvanic control and applied agitation to several modified versions of bath 1. In the modified baths, the disodium tungstate concentrations can be increased to approximately 0.1 M and 0.2 M, thus raising the tungstate:cobalt ratio in the bath. A number of cathode current densities can be employed in the range of approximately 1-4 Adm⁻² in each plating operation. The deposits can be demonstrated by XRD to be crystalline, and the hardness values can be in the range of approximately 900-1050 Hk, with the harder values being produced at 4 Adm⁻². EDX analysis on the deposits can show that they had high tungsten contents in the range of approximately 18-20 at %. This suggests that at higher tungsten concentrations, the bath contained increased cobalt-tungstate-gluconate concentrations which promote higher tungstate crystalline deposits even under agitated conditions. The increase in hardness may be achieved by refinement of grain size to approximately <5 nm, or the increase in tungsten in solid solution.

According to exemplary embodiments of the present disclosure, an as-deposited electroplated alloy can be created which can include an iron group metal with tungsten. The iron group metal can include cobalt, as described with regard to the exemplary embodiment above, or nickel or iron itself. This can be obtained by creating equilibria between the species and then overarching operational controls in terms of temperature, pH and current density, which defines the deposition rate and acceptability of the coating.

In an exemplary embodiment, the iron group metal ion can be provided at up to approximately 0.5M (cobalt and tungsten) ratio with other constituents of the bath, although potentially approximately 0.05M is a preferred ratio. Further, the source for the cobalt ion can be cobalt sulphate.

With regard to tungstate, in an exemplary embodiment, this can be provided by a disodium tungstate salt at up to approximately 0.5M ratio, and preferably approximately 0.05M. The gluconate can act as a complexing agent and as indicated above, advantageously may be provided in excess. In such circumstances the gluconate can be provided through a sodium gluconate salt at up to approximately 1M ratio, and in an exemplary embodiment, approximately 0.5M ratio.

The bath can include an aqueous solution in which sodium chloride can be added to aid bath conductivity at up to approximately 2M ratio, and in an exemplary embodiment, approximately 0.5M ratio with other constituents. As described above, provision of boron within the electroplated alloy may have advantages with regard to buffering of the bath to maintain pH, and can act as a minor complexant. In such circumstances, boric acid may be added at up to approximately 1 M ratio, and in an exemplary embodiment, approximately 0.5 M ratio with other constituents. Boron can be included in the deposits at a low level, and this may influence structure and properties.

The rate of deposition can depend upon the bath composition temperature, current density and pH of the bath. In an exemplary embodiment, the temperature can be in the range of approximately 50-90° C. although, as illustrated in the exemplary embodiment above, approximately 80° C. may be preferred.

With regard to current density, in an exemplary embodiment, the electrical current density can be in the range 1-4 Adm⁻², as shown by Hull cell tests. Typically, as in an exemplary embodiment, approximately 2.7 Adm⁻² may provide an acceptable deposition rate.

With regard to pH, in an exemplary embodiment, the pH can be in the range of approximately 5 to 7, but generally around approximately 6 pH can give appropriate results with regard to complex formation and the efficiency of deposition, which may be maintained at approximately 60%.

Agitation with regard to the bath may be advantageous in skewing the crystallinity for deposition and therefore hardness in the coating. Such skewing in the deposition to a harder deposition for other operational conditions in terms of bath constituency, temperature, current density and pH may be beneficial in comparison with altering these operational conditions themselves.

The rate of deposition may be significant with regard to controlling stress within the deposition, and therefore potential problems with regard to cracking. By adjusting the above operational conditions as well as bath composition, a deposition rate in the order of approximately 20 μm per hour may be achieved. Such a deposition rate can limit stresses within the coating. Where desirable, it may be possible to introduce a small compressive stress within the coating to accommodate for thermal or other dimensional cycling within an underlying component upon which the coating is applied.

Exemplary embodiments of the present disclosure can provide a method which allows a coating to be applied to a recipient cathode. The cathode can include an engineering component such as a shaft or other element subject to wear in use. The shaft can be placed within an appropriate electroplating bath, and the exemplary method performed. In such circumstances, electroplating deposition can be applied where required upon the component.

Examples and components may include shafts and bearings with a coating in the order of approximately 5 to 200 μm thick applied. Deposition of the electroplated coating in accordance with exemplary embodiments of the present disclosure can be generally linear, and therefore electroplating deposition can be performed at a deposition rate for an appropriate period of time. Exemplary embodiments of the present disclosure in view of the crystallinity of the coating and electrodeposition will be generally smooth as perceived at a surface level.

Generally, the coating in accordance with exemplary embodiments of the present disclosure can include columnar elements extending from the plated surface with a grain width in the order of less than approximately 5 nm. Such coatings upon components can generally achieve Knoop hardness levels approximately equivalent to that of hard chromium coatings. Thus, Knoop hardness values in excess of approximately 1000 Hk can be achieved on crystalline cobalt-tungsten alloy coatings.

Exemplary embodiments of the present disclosure described above with regard to cobalt can be substituted when utilizing other iron group elements in alloy with tungsten. In such circumstances, nickel sulphate or iron sulphate may be utilized in appropriate molar constituent proportions in order to create nickel tungsten and iron tungsten coatings.

Provision of coatings of an appropriate depth upon components such as shafts and other engineering applications can have particular advantages for wear resistance. Exemplary embodiments of the present disclosure can provide coatings which can match or improve upon those of hard chromium coatings. Generally, it can be desirable to provide a smooth coating of at least approximately 15 μm thickness, with a negligible level of cracking for maximum corrosion resistance. Such coatings can be capable of withstanding 3,000 hours in a neutral salt spray test (ASTM B117) Generally, exemplary embodiments of the present disclosure can provide a coating which can include a tungsten content less than approximately 25 at %, and typically less than approximately 20 at %, which can facilitate providing a highly crystalline coating with its enhanced wear characteristics, i.e. a very low coefficient of friction (approaching approximately 0.1) under dry loading conditions. At low loads, there may be no detectable wear on the coating, but at high loads, the measured sliding wear rates can be in the order of approximately 10⁻¹⁶ m³N⁻¹m⁻¹, which may an order of magnitude less than that for hard chromium coatings under the same condition By appropriate choice of electrode potential or current density, desired deposition of the iron group, e.g., a Co—W coating, can be achieved.

The foregoing merely illustrates the exemplary principles of the present disclosure. Various modifications and alterations to the described embodiments will be apparent to those skilled in the art in view of the teachings herein. It will thus be appreciated that those skilled in the art will be able to devise numerous modification to the exemplary embodiments of the present disclosure which, although not explicitly shown or described herein, embody the principles of the disclosure and are thus within the spirit and scope of the disclosure. All publications, applications and patents cited above are incorporated herein by reference in their entireties.

1-27. (canceled)

28. A method for electro-plating an alloy upon a cathode, comprising:
providing a bath which includes disodium tungstate and an iron group substrate in an aqueous solution with a complexant to form complexes which remain in suspension in the bath, and
maintaining the bath at a temperature in the range of approximately 50-90° C. and at a pH in the range of approximately 5 to 7 and a current density in the range of approximately 1 to 4 Adm⁻².

29. The method of claim 28, wherein the complexant includes at least one of a sodium gluconate salt, another carboxylic acid salt, or a sodium gluconate.

30. The method of claim 28, wherein the aqueous solution includes iron group ions at a composition proportion up to approximately 0.5M within the aqueous solution.

31. The method of claim 30, wherein the aqueous solution includes tungstate ions at a composition proportion up to approximately 0.5M within the aqueous solution.

32. The method of claim 28, wherein the complexant includes gluconate ions at a composition proportion up to approximately 1M within the aqueous solution.

33. The method of claim 28, wherein the aqueous solution includes H₃BO₃ at a composition proportion up to approximately 1M within the aqueous solution.

34. The method of claim 28, wherein the aqueous solution includes sodium chloride at a composition proportion up to approximately 2M within the aqueous solution.

35. The method of claim 30, wherein the iron group ions include cobalt ions provided by CoSO₄.

36. The method of claim 31, wherein the tungstate ions are provided by Na₂WO₄.

37. The method of claim 28, wherein the complexant includes gluconate ions, and wherein the gluconate ions are provided by Na gluconate.

38. The method of claim 28, wherein the bath is maintained at approximately 80° C. and at a pH of approximately 6, and wherein the current density is approximately 2.7 Adm-2.

39. The method of claim 28, further comprising agitating the bath.

40. The method of claim 39, wherein the agitation includes providing purge gas bubbling.

41. The method of claim 28, wherein at least one of the bath, the temperature, or the current density is configured to provide a deposition rate of approximately 20 μm per hour.

42. The method of claim 28, wherein at least one of the bath, the temperature or the current density is configured to facilitate at least one of limited deposition stressing within deposition upon the cathode or a degree of compression stressing of deposition upon the cathode.

43. The method of claim 28, wherein:
the complexant includes glutonate ions at a composition within the aqueous solution up to approximately 0.55 M,
the aqueous solution includes iron group ions at a composition proportion up to approximately 0.05 M, tungstate ions at a composition of up to approximately 0.05 M, H₃BO₃ up to approximately 1 M, and sodium chloride up to approximately 2 M,
the bath is maintained at a temperature of approximately 80° C. and a pH of approximately 6,
the current density is approximately 2.7 Adm-2, and
the deposition rate is approximately 20 μm per hour.

44. A component having a coating including an electro-plated alloy upon a cathode, the coating formed by providing a bath which includes disodium tungstate and an iron group substrate in an aqueous solution with a complexant to form complexes which remain in suspension in the bath, and maintaining the bath at a temperature in the range of approximately 50-90° C. and at a pH in the range of approximately 5 to 7 and a current density in the range of approximately 1 to 4 Adm⁻².

45. The component of claim 44, wherein the coating includes a thickness approximately 1 μm to 200 μm thick, is radially columnar with a grain size cross section less than approximately 10 nm, and wherein the coating has a Knoop hardness greater than approximately 800 kg mm-2.

46. A coating comprising less than approximately 25 at % tungsten in crystalline association with an iron group metal having a columnar grain orientation and a presentation extending laterally from a deposited surface in use.

47. The coating of claim 46, wherein the iron group metal includes at least one of cobalt, nickel, or iron.
